(19) United States
(12) Patent Application Publication
(10) Pub. No.: US 2005/0188172 A1
(43) Pub. Date: Aug. 25, 2005

(54) Reduction of address aliasing

(75) Inventor: Alex A. Lopez-Estrada, Chandler, AZ (US)

Correspondence Address: VENABLE LLP, P.O. BOX 34385, WASHINGTON, DC, 20045-9998, US

(73) Assignee: Intel Corporation, Santa Clara, CA (US)

(21) Appl. No.: 10/781,692

(22) Filed: Feb. 20, 2004

(51) Int. Cl. G06F 12/02

(52) U.S. Cl. 711/201; 711/170; 711/219

(57) ABSTRACT

Offsets may be used in memory architectures to reduce or avoid address aliasing.

### BACKGROUND OF THE INVENTION

Computer systems may employ a multi-level hierarchy of memory, with relatively fast, expensive, but limited-capacity memory at the highest level of the hierarchy proceeding to relatively slower, lower cost, but higher-capacity memory at the lowest level of the hierarchy. Typically, the hierarchy includes a small fast memory called a cache, either physically integrated within a processor or mounted physically close to the processor for speed. The computer system may employ separate instruction caches and data caches. In addition, the computer system may use multiple levels of caches. The use of a cache is transparent to a computer program at the instruction level and can thus be added to a computer architecture without changing the instruction set or requiring modification to existing programs.

A cache hit occurs when a processor requests an item from a cache and the item is present in the cache. A cache miss occurs when a processor requests an item from a cache and the item is not present in the cache. In the event of a cache miss, the processor retrieves the requested item from a lower level of the memory hierarchy. In many processor designs, the time required to access an item for a cache hit is one of the primary limiters for the clock rate of the processor, if the designer is seeking a single cycle cache access time. In other designs, the cache access time may be multiple cycles, but the performance of a processor can be improved in most cases when the cache access time in cycles is reduced. Therefore, optimization of access time for cache hits is critical to the performance of the computer system.

Associated with cache design is a concept of virtual storage. Virtual storage systems permit a computer programmer to think of memory as one uniform single-level storage unit but actually provide a dynamic address-translation unit that automatically moves program blocks on pages between auxiliary storage and the high speed storage (cache) on demand.

Memory may be organized into words (for example, 32 bits or 64 bits per word). The minimum amount of memory that can be transferred between a cache and the next lower level of memory hierarchy is called a line or a block. A line may be multiple words (for example, 16 words per line). Memory may also be divided into pages, or segments, with many lines per page. In some computer systems page size may be variable.

In modem computer memory architectures, a central processing unit (CPU) may produce virtual addresses that are translated by a combination of hardware and software to physical addresses. The physical addresses may then be used to access a physical main memory. A group of virtual addresses may be dynamically assigned to each page. A special case of this dynamic assignment is when two or more virtual addresses are assigned to the same physical page. This is called virtual address aliasing. Virtual memory requires a data structure, sometimes called a page table, that translates the virtual address to the physical address. To reduce address translation time, computers may use a specialized associative cache dedicated to address location, commonly called a dynamic translation look-aside buffer (DTLB).

FIG. 1 illustrates an example of a memory architecture 10. The memory depicted is a first level cache memory having 8 kilobytes (KB). The cache memory may be arranged into four ways 12, 14, 16, 18. Each of the ways 12, 14, 16, 18 may be two KB in size and may include thirty-two lines 20 of sixty-four bytes. A tag 22 for each cache line 20 per way may also maintained in the memory 10. The tag 22 may include the state of the cache line 20 and a page tag that may indicate to which page directory 25A, B, C, D a cache line 20 belongs.

A programmer may have a thirty-two bit linear address view of the memory. In order to access the memory, the programmer may use a thirty-two bit address 24. The thirty-two bit linear address 24 may be submitted to the DTLB 26. DTLB 26 may convert the linear address 24 into a thirty-six bit physical address 28. All memory references, for example, loads and stores, may first be submitted to the DTLB 26. The physical address 28 may contain portions 29, 30 that correspond to the cache line and page tag, respectively, to be used for cache lookup. In the cache lookup stage, all first level cache ways may be indexed by the cache line given by portion 29 of the physical address 28. Portion 29 may be included in bits 6-10 of the physical address 28. The cache then verifies the page tag defined in portion 30 of the physical address 28 on all cache ways 12, 14, 16, 18 to find a match for the physical address 28. The cache lookup comparison 32 may be done using only five bits of the page tag in portion 30, for a total of sixteen bits in the lookup. If a match for the page tag and cache line is found, the state of the cache line may be verified and modified according to the modified, exclusive, shared, invalid (MESI) protocol. In the case of a cache miss, the address may be passed to a second level cache.

Since only sixteen bits may be used for the cache lookup operation, unresolved conflicts may exist with locations that are aliased to addresses that are in the 64 KB range. That is, references that are 2¹⁶ bytes apart may not be resolvable in the first level cache. This may introduce a performance penalty termed “aliasing conflicts”. Aliasing conflicts occur when a cache reference, load or store, occurs when the sixteen bits of the linear address are identical to a reference, load or store, which is currently underway. The second reference cannot begin until the first reference is retired from the cache. In an example that uses sixteen bits for the linear address, every 64 KB (216) are aliased to the same cache line. This type of aliasing is therefore termed 64 K aliasing conflicts. Aliasing conflicts also exist for different numbers of bits for the address. Aliasing conflicts are a significant issue for many critical software applications and may cause serious performance problems.

### BRIEF DESCRIPTION OF THE DRAWINGS

The invention may be understood by referring to the following description and accompanying drawings, wherein like reference numbers generally indicate identical, functionally similar, and/or structurally similar elements.

FIG. 1 is a schematic diagram of a memory architecture;

FIG. 2 is a schematic diagram of a memory divided into memory blocks according to an exemplary embodiment of the invention;

FIG. 3 is a schematic diagram of another memory divided into memory blocks according to an exemplary embodiment of the invention;

FIG. 4 is a schematic diagram of a memory queue storing data according to an exemplary embodiment of the invention;

FIG. 5 is an example of pseudo code according to an exemplary embodiment of the invention; and

FIG. 6 is a flow chart of a method according to an embodiment of the invention.

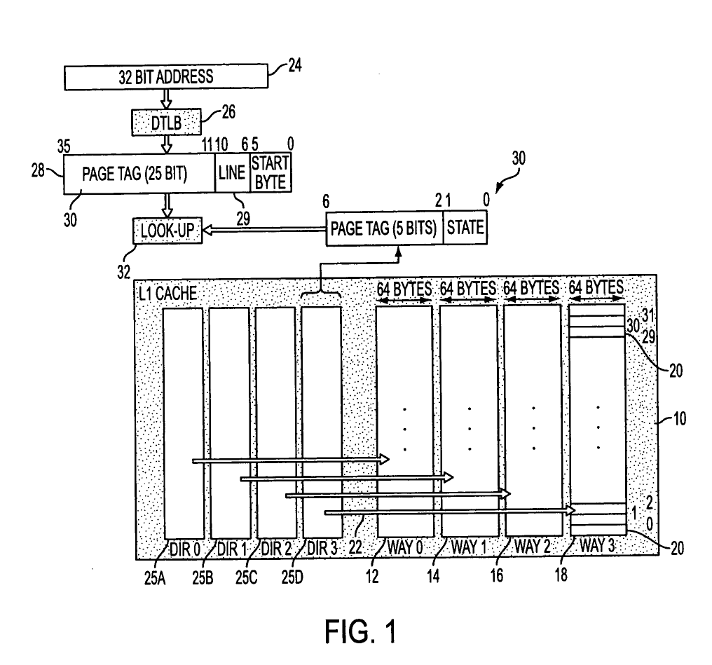

### DETAILED DESCRIPTION OF EXEMPLARY EMBODIMENTS OF THE PRESENT INVENTION

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-accessible medium, which may be read and executed by a computing platform to perform the operations described herein. A machine-accessible medium may include any mechanism for storing or transmitting information in a form readable by a machine (e.g., a computer). For example, a machine-accessible medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

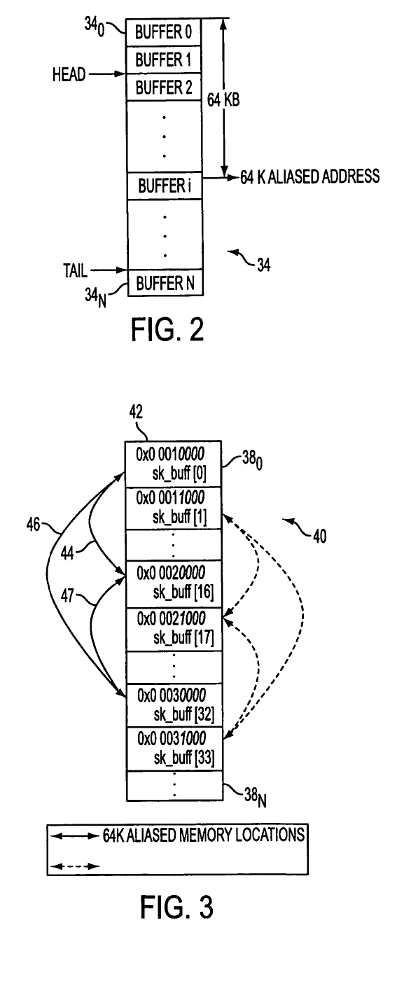

An exemplary embodiment of the invention provides a method for reducing address aliasing conflicts. A memory may be divided into a plurality of memory blocks. The location of data in a memory block may be offset in order to avoid aliasing conflicts. FIG. 2 illustrates an example of a memory 34 divided into a number of memory blocks 34_{0-N}. The memory blocks 34_{0-N} may have a uniform size. In this example, the memory blocks may be memory mapped buffers 34_{0-N}. The buffers 34_{0-N} may be organized as a ring buffer. If sixteen bits are used for the address cache look-up operation, every 64 KB in the memory 34 may be an aliased address. Although described below in conjunction with a ring buffer, embodiments of the present invention may also be used with other types of buffers, such as linear buffers, as well as with any type of memory that may have address aliasing conflicts. The specific number of memory blocks and the size of each memory block may depend on the particular implementation and application. Additionally, the method may be used explicitly by a compiler, such as providing compiler intrinsics to be used by a programmer, or implicitly, such as the compiler automatically recognizing the presence of potential aliased ring buffers and further optimizing the buffer allocations using this method.

For illustrative purposes, an example of aliasing conflicts in Internet Protocol (IP) forwarding is described below. This example may correspond to a Linux* IP stack. Consider an embedded platform including two network interface cards (NICS). Packets may be received on a first one of the NICs, queued in a packet backlog, and scheduled for network processing. The packets may then be sent on to the second NIC for transmission. A network queue may be programmed to hold up to 256 memory mapped buffers, 38₀-38₂₅₅, FIG. 3. These 256 memory mapped buffers 38 may make up a ring buffer 40. 4 KB of memory may be allocated for each IP packet. Therefore, each buffer 38 may have a size of 4 KB.

Assuming the buffers 38 have a size of 4 KB, every sixteenth IP packet may have an aliased memory address. For example, as shown in FIG. 3, the packet ring buffer 40 may be divided into 256 socket buffers 38. Each socket buffer 38 may have an address 42. The address 42 for the socket buffers 38 may be repeated every sixteenth buffer. Thus, the addresses for buffers 38₀-38₁₅ may be repeated for buffers 38₁₆-38₃₁, and may then be repeated again for buffers 38₃₂-38₄₈, etc. As indicated by arrow 44, the address for socket buffer 38₀ may be repeated for socket buffer 38₁₆; and repeated again for buffer 38₃₂, arrows 46, 47. The address for socket buffer 38₁, may be repeated for socket buffers 38₁₇ and 38₃₃ and so on. If the ring buffer 40 holds up to 256 packets and the packets are allocated contiguously in memory, then there may be at least sixteen aliased addresses per packet. The network stack and kernel may reference all of the packets in the queue, and aliasing conflicts may occur. As an example, the network stack may consume packets at a rate such that the queue averages 256 packets. At any instance in time, there may be sixteen aliasing conflicts per packet. If the network stack consumes packets so that the queue may average 128 packets, there may be 8 conflicts per packet, and so forth.

In order to reduce the number of aliasing conflicts, a location of data in at least one of the memory buffers 38 may be offset. The offset may be achieved by offsetting a pointer to each possible aliased buffer by a number of cache lines in order to avoid address aliasing. The offset may be determined based on the amount of data to be stored in the buffer. For example, in the IP forwarding case described above, the NIC driver and network stack may reference at most sixty bytes of IP header. This may consume twenty bytes default and forty bytes of IP options. An additional fourteen bytes may be provided for an Ethernet header, for a total of seventy-four bytes. Each cache line in the memory may be made up of sixty-four bytes. Therefore an offset of two cache lines, 128 bytes, may locate the data in the buffer to avoid address aliasing. The data in those buffers that may have aliasing conflicts may be offset from the beginning of the buffer by two cache lines.

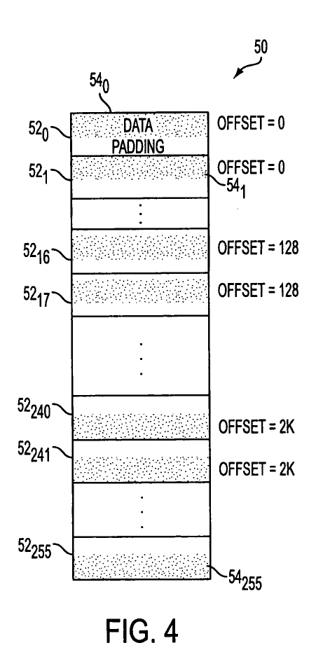

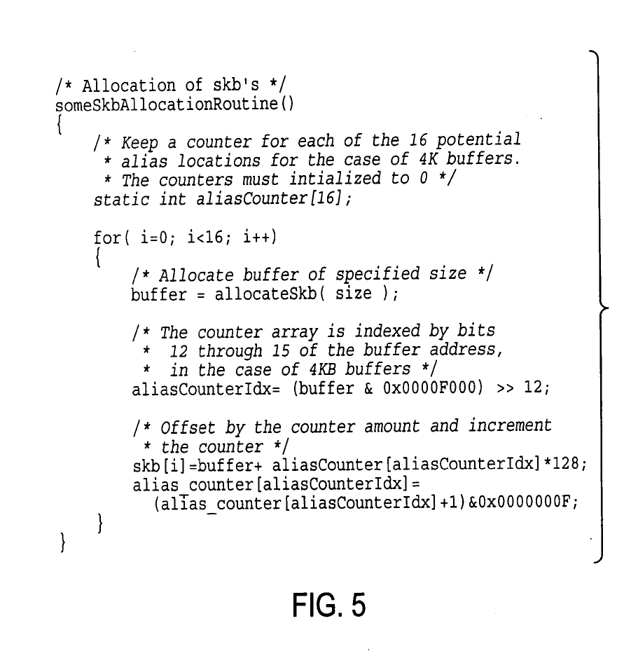

In an exemplary method of determining the offset, the number of possible alias locations in the ring buffer 40 may be determined. A count of the number of possible aliased locations may be kept. A specific offset for each buffer 38 may be determined by multiplying the counter by the size of the offset. As each new alias to an original address is found, the counter is incremented by one. FIGS. 4 and 5 illustrate an example of this approach. In FIG. 4, a memory queue 50 is illustrated. The memory queue 50 may be comprised of a number of socket buffers 52. In this example, the memory queue 50 includes 256 socket buffers 52₀-52₂₅₅. Data may be stored in a data field 54 in the socket buffers 52. Socket buffer 52₀ includes data field 54₀, socket buffer 52₁ includes data field 54₁ and so on. An offset for the data fields 54 within the socket buffers 52 may be determined according to the exemplary method described above. In this example, the socket buffers may be 4 KB buffers, although other size buffers are also possible. Consequently, every sixteenth socket buffer 52 may have an address aliasing conflict. The offset in bytes for a buffer k may be determined by the following equation:
Offset=128*└k/16┘;
where is └X┘ the nearest integer that is less than or equal to X.

Accordingly, for the first sixteen buffers 52₀₋₁₅, the offset may be zero bytes. For the next sixteen buffers, the offset may be 128 bytes. Thus, the data field 54 for each of socket buffers 52₁₆₋₃₁ may be offset by 128 bytes or two cache lines as is shown in FIG. 4. For socket buffers 54₂₄₀₋₂₅₅, the offset may be 2K, and so on. Data may be written to buffers based on the offset. FIG. 5 illustrates pseudo-code that may be used for this approach.

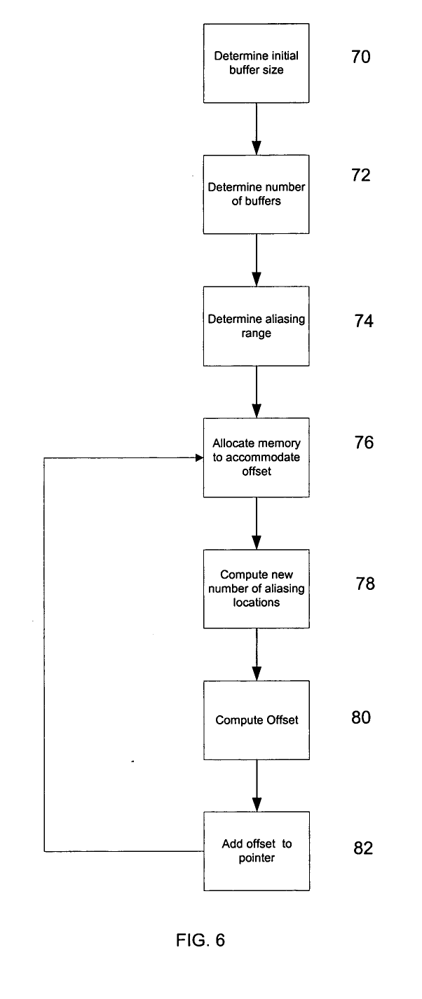

Referring now to FIG. 6, a flow chart according to another exemplary method of the invention is described. An initial size for the buffer or memory blocks and the number of buffers in the memory may be determined, per blocks 70, 72. This determination may be made depending upon the specific implementation. An aliasing range may also be determined, block 74. The aliasing range may be the number of bytes between aliased locations, for example, 64 KB for 64K aliasing. The aliasing range may also depend on the specific implementation. Based on this information, the number of possible alias locations may be determined. For example, the number of possible aliased locations may be found using the following equation:
M=N*B/AR (1)
where M is the number of aliased locations, N is the intended number of buffers, B is the intended size of the buffer and AR is the number of bytes between aliased locations. For the example of 64K aliasing, equation (1) becomes M=256*2048/65536=8.

Additional memory may be allocated to each buffer to ensure that the buffer is appropriately sized to accommodate both the data to be stored as well as the maximum offset, block 76. The new buffer size may be determined using the following equation:
B′=B+M*NCL*CLS (2)
where B′ is the new buffer size given in bytes, M is computed from equation (1), NCL is the number of desired offset cache lines, and CLS is the cache line size in bytes. CLS may depend upon a particular processor being used and may be implementation specific. The number of offset cache lines may be input by a user or may be a fixed number. Again, the number of offset cache lines may be implementation specific. In the IP forwarding example given above, the number of offset cache lines may be two, and for a Pentium® 4 processor (produced by Intel corp., Santa Clara, Calif.), the cache line size may be 64 bytes.

A new number of possible aliased locations may be determined based on the new buffer B size, block 78. The new number of possible aliased locations may be determined using the following equation:
M=N*B′/AR (3)

The process may return to block 76 to reallocate memory to hold the maximum offset based on the new number of aliased locations M′. This process may be repeated as often as desired, but may preferably be repeated once. The process may then proceed to block 80. Per block 80, an offset for each memory buffer may be determined. The offset may be determined for each memory block K using the following equation:
Oₖ=NCL·CLS·mod(└k/(N/M′)┘,M′)k=0,1,2 . . . N−1 (4)

A modulo operation is used so that the allocated buffer size does not overflow. Accordingly, the offset may wrap around every number of possible aliased locations (M). The location of the data within the memory may then be varied based upon the offset. This may be done by adding the appropriate offset to a pointer to each memory location block 82. The offset may be computed for each memory block K using the following equation:
Pointerₖ=Pointerₖ+Oₖk=0,1,2 . . . N−1

This process may significantly reduce the number of aliasing conflicts. The process may be applied to any application that uses ring buffers or other addressing techniques in which address aliasing is possible. Additionally, although the invention has been described with reference to NIC processing, the same approach is also applicable to any memory mapped I/O device and any user level applications that use buffers or memory blocks.

The embodiments illustrated and discussed in this specification are intended only to teach those skilled in the art the best way known to the inventors to make and use the invention. Nothing in this specification should be considered as limiting the scope of the present invention. The above-described embodiments of the invention may be modified or varied, and elements added or omitted, without departing from the invention, as appreciated by those skilled in the art in light of the above teachings. It is therefore to be understood that, within the scope of the claims and their equivalents, the invention may be practiced otherwise than as specifically described.

1. A method, comprising:
offsetting a location of data in at least one of a plurality of memory blocks to avoid aliasing conflicts.

2. The method of claim 1, further comprising:
determining a uniform size for the memory blocks, the size being large enough to accommodate the data and the offset.

3. The method of claim 1, wherein the memory blocks are buffers.

4. The method of claim 3, wherein the buffer is a ring buffer.

5. The method of claim 3, wherein the buffer is a linear buffer.

6. The method of claim 1, further comprising dividing a memory into the plurality of memory blocks such that the memory blocks are of equal size.

7. The method of claim 1, further comprising:
determining possible aliased locations in the plurality of memory blocks;
changing a size of the memory blocks to a new size to accommodate the data and an offset;
determining a number of possible aliasing locations based on the new size; and
determining the offset based on the new number of possible aliasing locations.

8. The method of claim 7, further comprising adding the offset to a pointer for respective memory blocks.

9. A method, comprising:
a) determining possible aliased locations in a memory comprising of a number of buffers;
b) increasing a count when a buffer that is a possible aliased location is found; and
c) storing data in the buffers at a location that is offset based on the count and a number of bytes selected for offset.

10. The method of claim 9, wherein the offset is a product of the count and the number of bytes.

11. The method of claim 9, further comprising repeating a)-c).

12. The method of claim 9, further comprising dividing the memory into a number of buffers of equal size.

13. A method, comprising:
computing a number of aliased address locations in a memory including a number of memory blocks;
allocating extra memory to the memory blocks based on the number of aliased address locations to obtain a new size for the memory blocks;
computing a second number of aliased address locations based on the new size for the memory blocks; and
computing an offset for data within the memory blocks based on the second number of aliased address locations.

14. The method of claim 13, further comprising adding the offset to a pointer for data within the memory blocks.

15. The method of claim 13, further comprising computing the number of aliased address locations based on at least one of a number of memory blocks, an intended size for the memory blocks, and an aliasing range.

16. The method of claim 13, further comprising allocating extra memory to the memory blocks based on at least one of the number of aliased address locations, a line size, and a line offset.

17. A machine accessible medium that provides instructions, which when executed by a computing platform, cause said computing platform to perform operations comprising a method of:
determining a physical address based on a linear address;
determining a possible aliased address for the physical address;
modifying the aliased address; and
accessing memory based on the modified aliased address.

18. The machine accessible medium of claim 17, further comprising instructions, which when executed by a computing platform, cause said computing platform to perform further operations of computing a number of aliased addresses based on at least one of a number of memory blocks, an intended size for the memory blocks in the memory, and an aliasing range.

19. The machine accessible medium of claim 18, further comprising instructions, which when executed by a computing platform, cause said computing platform to perform further operations of:
allocating additional memory to the memory blocks to obtain a new size for the memory blocks;
computing a second number of aliased address locations based on the new size for the memory blocks; and
computing an offset for the memory blocks based on the second number of aliased address locations.

20. The machine accessible medium of claim 19, further comprising instructions, which when executed by a computing platform, cause said computing platform to perform further operations of adding the offset to pointer for the memory blocks.

21. A machine accessible medium that provides instructions, which when executed by a computing platform, cause said computing platform to perform operations comprising a method of:
storing data at memory locations within a plurality of uniformly sized memory blocks based on an offset.

22. The machine accessible medium of claim 21, further comprising instructions, which when executed by a computing platform, cause said computing platform to perform further operations of:
receiving an original address;
determining possible aliases for the original address;
determining the offset for the possible aliases; and
modifying a pointer to the memory locations of the aliases based on the respective offset.

23. The machine accessible medium of claim 21, further comprising instructions, which when executed by a computing platform, cause said computing platform to perform further operations of:
increasing a count when a memory location that is a possible alias is found; and
storing data within the memory blocks at a location that is offset based on the count and a number of bytes selected for offset.

24. The machine accessible medium of claim 23, further comprising instructions, which when executed by a computing platform, cause said computing platform to perform further operations of computing the offset as a product of the count and the number of bytes.

25. A system comprising:
a processor;
a memory divided into memory blocks;
a pointer to point to locations in the memory blocks, the pointer for memory blocks having aliased addresses being offset from on another.

26. The system of claim 25, wherein the memory blocks have a uniform size.

27. The system of claim 25, further comprising a dynamic translation look-aside buffer to determine addresses.
